(19) United States
(12) Patent Application Publication
(10) Pub. No.: US 2006/0137390 A1
(43) Pub. Date: Jun. 29, 2006

(54) Carbon dioxide driven electrical power plant

(76) Inventor: Donald Iverson, Clearwater Beach, FL (US)

Correspondence Address: DENNIS G. LAPOINTE;LAPOINTE LAW GROUP, PL, PO BOX 1294, TARPON SPRINGS, FL, 34688-1294, US

(21) Appl. No.: 11/025,535

(22) Filed: Dec. 29, 2004

(51) Int. Cl. F17C 7/02; F25D 15/00; F25D 23/12; F25J 1/00

(52) U.S. Cl. 62/602; 62/331

(57) ABSTRACT

A carbon dioxide driven electrical power plant for integration with surrounding utilities. This power plant uses the earth's gravitational effect on mass, provided by solid carbon dioxide, to create work. This work is then harnessed in the form of electrical power. The carbon dioxide gas released during the formation of dry ice and during the sublimation stage when the dry ice is dispensed at the bottom of a vertical shaft is recycled through a gas filtration system and liquefaction system to create additional dry ice.

This application relates to alternative sources of energy production in the form of the production of electricity using carbon dioxide blocks.

### BACKGROUND OF THE INVENTION

There are many alternative sources of energy for the generation of electricity such as windmills, solar panels, hydroelectric dams, etc. All have several associated problems such as number of windmills required, area of land needed for the windmills, obstruction of waterways, and environmental problems. The present invention attempts to solve several problems plaguing the energy sector at present, including non-renewable resource consumption, hazardous environmental waste, inconsistent reliability, and production inefficiency.

The present invention takes into consideration technologies employed in energy production facilities, mineshaft drilling and deep earth conditions, carbon dioxide filtering and condensing, cable and elevator innovations, general aerodynamics, and physics.

### SUMMARY OF THE INVENTION

The invention, which is a carbon dioxide driven power plant creates usable electricity from the transformation of linear momentum to angular momentum using the interaction of the Earth's gravitational field. The potential energy of a falling block of solid carbon dioxide, dry ice, is captured with the use of a high-strength cable and container circuit, which in turn creates torque on an electrical generator shaft.

The carbon dioxide, which provides the mass, changes phase three times, from gas to liquid to solid and back to gas, liquid and solid, as it is used in the process over and over again. This recycling of a single, plentiful resource separates it from most current forms of energy production. The fact that the source is reliable, unlike solar or wind, also differentiates it. The most similar technology widely used today is hydroelectric. The main difference with this type of energy production is the limited availability of suitable locations with hydroelectric power. The present invention is terrestrial; however, not nearly as location specific as other reusable resource power technologies, such as solar panels, windmills and hydroelectric systems.

The present invention is therefore a system for the generation of electrical power comprising carrier means for holding dry ice; means for delivering dry ice to the carrier means; means for causing the carrier means to travel vertically between upper and lower sheave systems, wherein a weight of the dry ice being contained by the carrier means causes the carrier means to travel downwardly creating momentum and potential energy, which in turn rotates the engaged upper and lower sheave systems; generator means for generating electricity; and the upper sheaves are in mechanical communication with the generator means, where a rotational torque is created from the rotation of the upper sheaves, which in turn energizes the generator means.

The system further comprises means for making dry ice wherein the means for making dry ice comprises a carbon dioxide gas recycling system, including a carbon dioxide gas filtration system; a carbon dioxide liquefaction system; and a carbon dioxide solidification system, wherein the dry ice (solidified carbon dioxide) is delivered to the carrier means by a dry ice conveyor system adapted to deliver at desired time intervals, the dry ice to the carrier means.

The invention further includes means for delivering the dry ice to the carriers through a dry ice conveyor system adapted to deliver at desired time intervals, the dry ice to each carrier, which is a container adapted to receive, temporarily hold and transport the dry ice down a shaft.

The means for causing the carrier means to travel vertically between the upper and lower sheave systems comprises a vertical shaft extending from near the upper sheave system to a floor portion below the lower sheave system, wherein the floor portion of the vertical shaft is spaced below the lower sheave system so as to allow for the discharge or dispensing of the dry ice from the containers as the containers each rotate around the lower sheave system to commence its vertical travel back toward the upper sheave system. The vertical shaft is of sufficient height to create a desired energy output from the electrical generators caused by the descending dry ice.

The carbon dioxide gas recycling system further comprises a fan driven duct system in gaseous communication with a floor portion of a vertical shaft. As the dry ice accumulates and sublimates at the floor portion, the released carbon dioxide gas is vented back through the fan driven duct system for recycling through the filtration system and the liquefaction system to make additional dry ice.

The container has an aerodynamically shaped bottom area for reducing frictional drag caused by the travel of the container holding the dry ice. This can be bullet shaped or tapered or conical or any other aerodynamic shape desired.

Two spaced-apart main cables are provided, in between which, each container is suspended and secured with additional cables attached from each end of each container to the respective spaced-apart main cables, where the two main cables are in turn engaged with the upper and lower sheave systems for continuous looping around the sheaves.

Multiple carriers are provided in a spaced-apart relationship to the cable and pulley or sheave system and adapted to receive the dry ice at desired time intervals.

The carbon dioxide solidification system comprises means for compressing formed dry ice chips, which are conveyed to a mold to form dry ice blocks. Each formed dry ice block is, in turn, delivered to the next carrier in line. A press is typically used for this function and after the block of desired size and weight is formed, it is released through a delivery tube or other conveyor system to the container attached to the sheave/cable system.

The carbon dioxide gas recycling system further comprises equipment and apparatus for recycling carbon dioxide gas released in the formation of the dry ice chips back through the gas filtration system to the liquefaction system. As the dry ice is initially formed, it is typically in the form of chips as noted above. In this process, gaseous carbon dioxide is formed and released and recycled back through the gas filtration system.

As the dispensed dry ice accumulates on the floor of the vertical shaft, it may be preferred to accelerate the sublimation of the dry ice using apparatus and equipment to generate a heat or to dispense salt crystals.

The invention further includes the methodology for generating this alternative source of energy in the form of electricity by causing the rotation of one or more electrical generators by the use of dry ice descending under its own gravitational force down a vertical shaft where the dry ice is contained in a carrier attached to cables connected to a sheave system attached to said one or more electrical generators and a corresponding sheave system at a lower end of the vertical shaft, where the vertical shaft is of sufficient height to create a desired energy output from the electrical generators caused by the descending dry ice.

The dry ice is generated on site using a carbon dioxide recycling system comprising a carbon dioxide gas recycling system, including a carbon dioxide gas filtration system, a carbon dioxide liquefaction system and a carbon dioxide solidification system; and the dry ice is delivered through a delivery conveyor system to each respective carrier.

The carbon dioxide solidification system creates dry ice chips, which are conveyed to compression means for forming dry ice blocks, which in turn are delivered to the carrier.

The dry ice is dispensed on a floor of the vertical shaft where the dispensed dry ice sublimates and the carbon dioxide gas is recycled through the carbon dioxide gas recycling system using a fan driven duct system back through the carbon dioxide gas filtration system and liquefaction system to make additional dry ice.

A plurality of carriers are provided in a spaced-apart relationship and adapted to receive the dry ice at desired time intervals.

Sublimation of the dry ice dispensed on the floor portion of the vertical shaft can be accelerated by the use of a heat source or by the use of salt crystals.

### BRIEF DESCRIPTION OF THE DRAWINGS

In the accompanying drawings:

FIG. 1 is a conceptual depiction of one example of the invention where twin generators are incorporated and are in mechanical communication with the pulleys or sheave system which rotate from the linear movement of the cable with the dry ice blocks;

FIG. 2 is a conceptual schematic drawing of the upper part of FIG. 1;

FIG. 3 is a conceptual schematic drawing depicting the shaft portion and how the dry ice block descends down the shaft gaining momentum, is dropped in an accumulation area at the bottom of the shaft for sublimation and recycling back as a gas through the power vented duct to the power plant; and

FIG. 4 is a conceptual depiction of the lower shaft portion of FIG. 3.

### DETAILED DESCRIPTION OF THE INVENTION

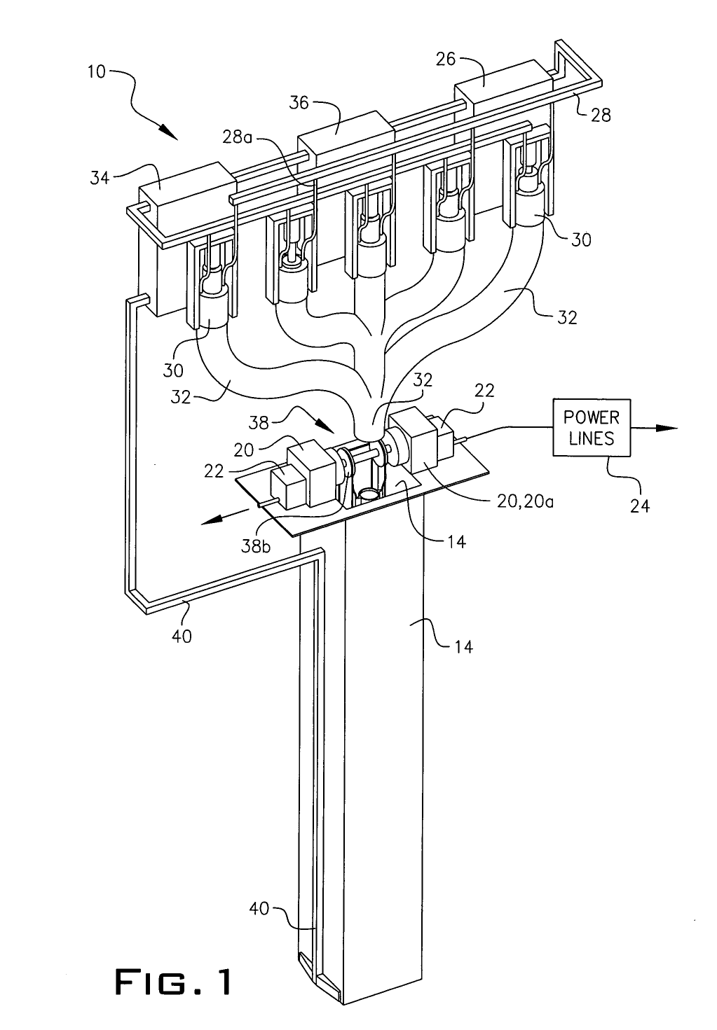

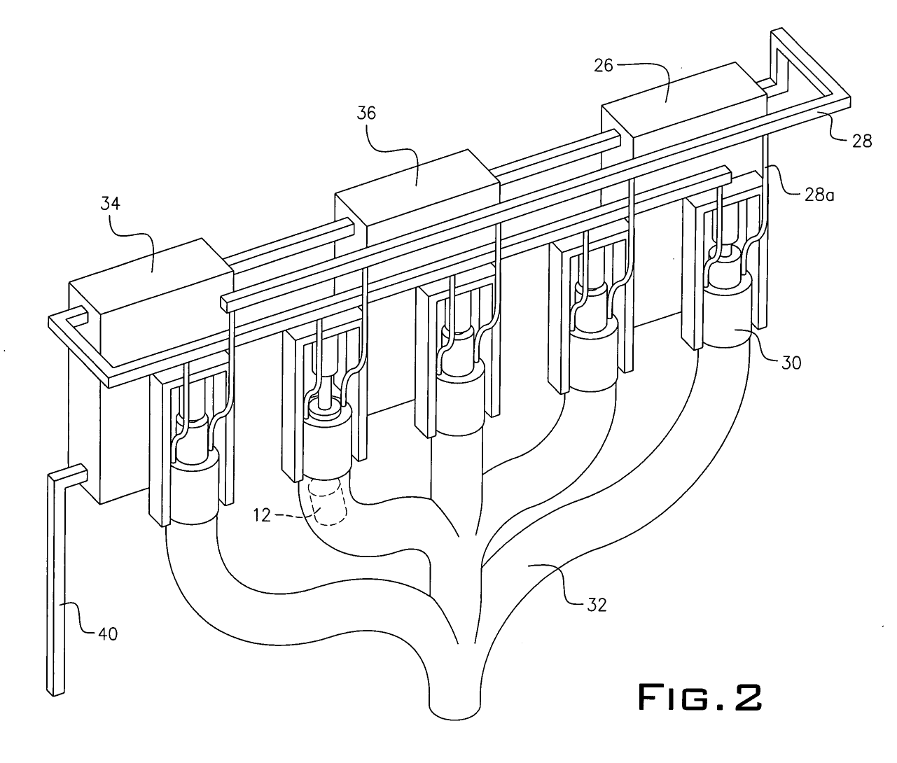

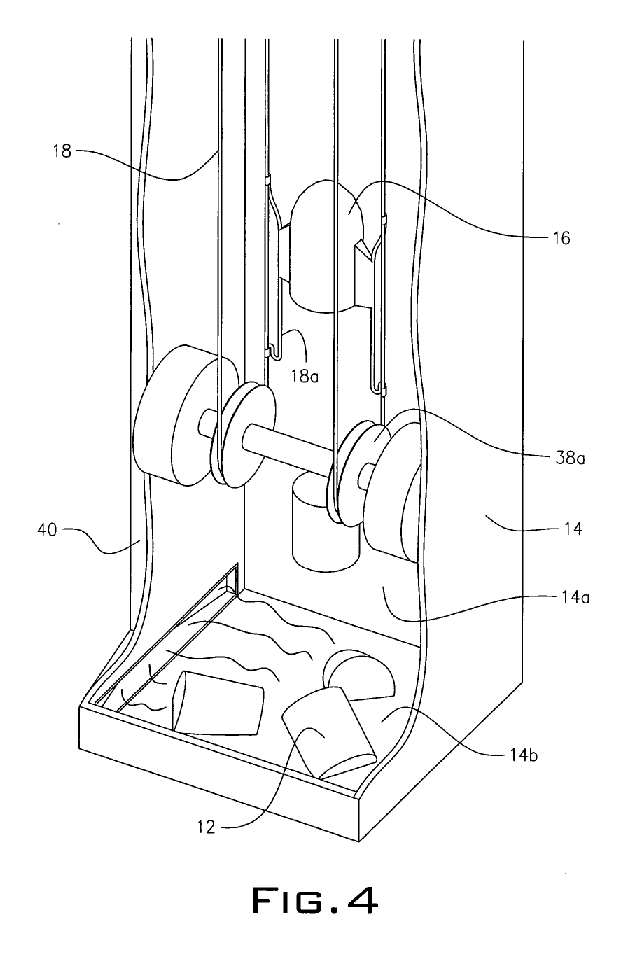

Referring now to the drawings, FIGS. 1-4 disclose conceptually an example of the application of the present invention, which is a carbon dioxide driven electrical power plant system, depicted generally as 10.

The carbon dioxide driven power plant 10 uses heavy blocks of dry ice 12 falling down a vertical shaft 14 in a container 16 attached to a cable circuit or system 18 to create the torque necessary to operate one or more an electric generators 20. Dry ice 12 is used, as opposed to water ice or metal, because once the block reaches the bottom of the shaft 14, it will sublimate and become a gas, which is easy to bring back to the surface and recycle. This invention can be broken down into three main systems: carbon dioxide recycling, vertical shaft, and energy production, which when operating symbiotically, will produce electrical power without pollution, in a closed system which can be added to the local power grid using transformers 22 and power lines 24.

The carbon dioxide recycling area can be further broken down into three processes: filtration of collected gas, compression to liquid, and creation of dry ice blocks. All three of these procedures require technology currently employed by the carbon dioxide manipulation industry. In this area, carbon dioxide is initially introduced from holding/supply tanks 26 of liquid carbon dioxide. This liquid carbon dioxide is stored in tanks and flow to the dry ice creation area via a central pipe 28. The liquid carbon dioxide flows from the central pipe 28 and is dispersed to smaller tubes 28a, which direct the liquid to the expansion valves (not shown for sake of simplicity in the drawings) in the side of dry ice molds 30. As the liquid carbon dioxide expands, it goes through phase changes to become both a solid, 40% to 50%, and a gas, 50% to 60%. The solid, in the form of ice chips, accumulates in the mold and is pressed to form a dry ice block, which is released though a removable floor panel (not shown for sake of drawing simplicity) into the delivery tube system 32 for use. The gaseous percentage of this process is recaptured and pumped to the collection area, which includes a gas purification or filtration system and a holding area, which collectively is generally depicted as 34. This area is basically a holding point for all the recaptured carbon dioxide gas from both the dry ice molds 30 and the bottom 14a of the vertical shaft 14 where the used dry ice blocks 12 accumulate to sublimate. From this holding point, the gas is pumped after being filtered on to the liquefaction stage in a liquefaction system generally depicted as 36. After the gas is compressed into liquid form, it is ready to enter the central pipe 28 to the dry ice molds 30 once again. In this way, the process loops, creating a closed system of carbon dioxide recycling and phase changing.

The vertical shaft 14 is where the majority of the motion of the power plant takes place. The moving component in this area is a circuit of lightweight, high-strength cables 18, around two points of rotation, one at the top of the shaft 14, connected directly to the generator(s) 20, and one near the bottom portion 14a of the shaft 14 to keep tension on the cable circuit 18. These points of rotation are provided by a system 38 of pulleys or sheaves 38a,38b of the appropriate size to create the required gear ratio and rotation velocity to create the torque needed to efficiently run the generator at the surface. Attached to this cable circuit 18 are several lightweight, aerodynamic containers 16 designed to support dry ice blocks 12. As the blocks 12 drop out of the delivery tubes 32, they are individually caught by the each container 16 and the cable circuit 18 begins to rotate as the weight of the ice 12 accelerates towards the bottom of the vertical shaft 14. When the container 16 of dry ice 12 reaches the lower sheave 38a, it rotates around the sheave and begins the return trip to the surface. This causes the container 16 to invert and the dry ice block 12 drops out due to gravitational force, that is, its own weight, to the floor 14b of the vertical shaft 14. The cable circuit 18, however, is compelled to continue its rotation as the next block of dry ice 12 enters an empty container 16 already rotating around the upper sheave 38b creating the extra weight needed to pull it towards the bottom. In this way, there is continuous torque being provided to the generator(s) 20 connected to the upper sheave 38b.

The container 16 is attached to the cable system looping around the pulleys 18a,18b with shorter cables 18a to alleviate stress on the container 16 as the container 16 travels around each pulley system 38a,38b.

As mentioned above, it is preferable to design the containers 16 aerodynamically. For example, the leading end of the container 16 can be bullet shaped, tapered, conical shaped or another design to lower drag coefficient at high velocity. The bullet shaped container seemingly would allow for minimal drag on the container 16 with higher carrying capacity for the container 16.

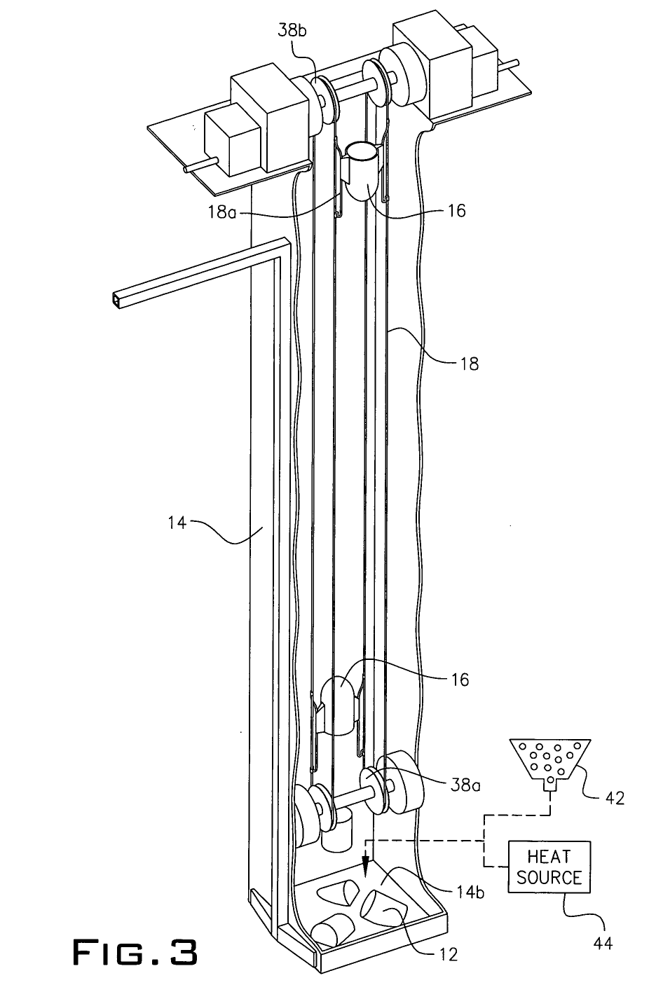

The shaft also includes a carbon dioxide gas collection duct system 40 to transport the gas, when it reaches a high concentration, from the bottom portion 14a of the shaft 14 back up to the carbon dioxide recycling area. The carbon dioxide gas will accumulate on the bottom of the shaft 14, as it is denser than air. In doing this, virtually all carbon dioxide used in the process is recycled. This duct system 40 includes blower or suction means for directing the gas away from the shaft floor. Typically fans or blowers can be incorporated at the lower end, an intermediate location or preferably at the upper end of the duct system 40. The upper end facilitates access for maintenance purposes. The bottom of the shaft may also be equipped with a heat source system 44 or salt crystals through a salt crystal delivery system, both systems conceptually depicted in FIG. 3, in order to hasten the sublimation of the used dry ice 12 and prevent large build-ups. The dimensions of this shaft 14 may vary, not only to be customized to the amount of energy to be produced, but, in some cases, to simply conform to a pre-existing mine shaft that has been acquired for the project. However, the diameter of the shaft 14 must be at least large enough to accommodate two of the aerodynamic containers 16 side by side and the diameter of the sheaves 38a,38b around which the cable circuit 18 rotates. Obviously, the deeper the shaft 14, the longer gravity can do work on the mass of dry ice 12. Therefore, there will be a minimum depth to which the shaft 14 can reach which will depend on the cost analysis relationship of producing each block of dry ice 12 to the amount of electricity that block can generate at the current price per kilowatt hour. The maximum depth, probably not a necessary concern for practical purposes, is the point at which the block sublimates within the container 16 so that it no longer provides enough linear momentum to keep the circuit 18 in rotation.

The energy production area is responsible for electromagnetic production via generators 20 and ramping up of the produced electricity via transformers 22 for subsequent transfer out of the plant via high voltage wires 24 and into the local power grid, as shown in FIG. 1. The generator coil 20a rotates from the direct connection to the upper cable circuit sheave 38b. Generator and transformer size will depend on the dimensions of the vertical shaft 14 and, thus, potential torque that can be created.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. A system for the generation of electrical power comprising:
carrier means for holding dry ice;
means for delivering dry ice to the carrier means;
means for causing the carrier means to travel vertically between upper and lower sheave systems, wherein a weight of the dry ice being contained by the carrier means causes the carrier means to travel downwardly creating momentum and potential energy, which in turn rotates the engaged upper and lower sheave systems;
generator means for generating electricity; and
the upper sheaves being in mechanical communication with the generator means, wherein a rotational torque is created from the rotation of the upper sheaves, which in turn energizes the generator means.

2. The system according to claim 1, further comprising:
means for making dry ice.

3. The system according to claim 2, wherein the means for making dry ice comprises:
a carbon dioxide gas recycling system, including a carbon dioxide gas filtration system;
a carbon dioxide liquefaction system; and
a carbon dioxide solidification system,
wherein dry ice being solidified carbon dioxide is delivered to the carrier means by a dry ice conveyor system adapted to deliver at desired time intervals, said dry ice to the carrier means.

4. The system according to claim 1, wherein means for delivering said dry ice to the carrier means is a dry ice conveyor system adapted to deliver at desired time intervals, said dry ice to the carrier means.

5. The system according to claim 1, wherein the carrier means is a container adapted to receive and hold the dry ice.

6. The system according to claim 1, wherein the means for causing the carrier means to travel vertically between the upper and lower sheave systems further comprises:
a vertical shaft extending from near the upper sheave system to a floor portion below the lower sheave system, wherein the floor portion of the vertical shaft is spaced below the lower sheave system so as to allow for the discharge of said dry ice from the carrier means as said carrier means rotates around the lower sheave system to commence its vertical travel back toward the upper sheave system,
wherein the vertical shaft is of sufficient height to create a desired energy output from the electrical generators caused by the descending dry ice.

7. The system according to claim 3, wherein the carbon dioxide gas recycling system further comprises:
a fan driven duct system in gaseous communication with a floor portion of a vertical shaft extending from near the upper sheave system to said floor portion below the lower sheave system, wherein the floor portion of the vertical shaft is spaced below the lower sheave system so as to allow for the discharge of the dry ice from the carrier means as said carrier means rotates around the lower sheave system to commence its vertical travel back toward the upper sheave system,
wherein as the dry ice accumulates and sublimates at the floor portion, the released carbon dioxide gas is vented back through the fan driven duct system for recycling through the filtration system and the liquefaction system to make additional dry ice.

8. The system according to claim 5, wherein the container has an aerodynamically shaped bottom area for reducing frictional drag caused by the travel of the container holding the dry ice.

9. The system according to claim 1, wherein the means for causing the carrier means to travel vertically between the upper and lower sheave systems comprises two spaced-apart main cables in between which said carrier means is suspended and secured with additional cables attached from each end of the carrier means to the respective spaced-apart main cables, said two spaced-apart main cables being in turn engaged with the upper and lower sheave systems.

10. The system according to claim 1, comprising a plurality of carrier means spaced-apart and adapted to receive said dry ice at desired time intervals.

11. The system according to claim 3, wherein the carbon dioxide solidification system comprises means for compressing formed dry ice chips conveyed to a mold to form a dry ice block, which in turn is delivered to the carrier means.

12. The system according to claim 11, wherein the carbon dioxide gas recycling system further comprises:
means for recycling carbon dioxide gas released in the formation of the dry ice chips back through the gas filtration system to the liquefaction system.

13. The system according to claim 6, further comprises:
means for accelerating the sublimation of the dry ice dispensed on the floor portion of the vertical shaft.

14. The system according to claim 13, wherein the means for accelerating the sublimation of the dry ice dispensed on the floor portion of the vertical shaft is a heat source means.

15. The system according to claim 13, wherein the means for accelerating the sublimation of the dry ice dispensed on the floor portion of the vertical shaft comprises means for providing salt crystals to said floor portion.

16. A method for generating electrical power comprising:
causing the rotation of one or more electrical generators by the use of dry ice descending under its own gravitational force down a vertical shaft where the dry ice is contained in a carrier attached to cables connected to a sheave system attached to said one or more electrical generators and a corresponding sheave system at a lower end of the vertical shaft, the vertical shaft being of sufficient height to create a desired energy output from the electrical generators caused by the descending dry ice.

17. The method according to claim 16, further comprising:
generating the dry ice on site using a carbon dioxide recycling system comprising a carbon dioxide gas recycling system, including a carbon dioxide gas filtration system, a carbon dioxide liquefaction system and a carbon dioxide solidification system; and
delivering said generated dry ice through a delivery conveyor system to each respective carrier.

18. The method according to claim 17, wherein the carbon dioxide solidification system creates dry ice chips, which are conveyed to compression means for forming dry ice blocks, which in turn are delivered to the carrier.

19. The method according to claim 17, further comprising:
dispensing the contained dry ice on a floor of the vertical shaft where said dispensed dry ice sublimates and the carbon dioxide gas is recycled through the carbon dioxide gas recycling system using a fan driven duct system back through the carbon dioxide gas filtration system and liquefaction system to make additional dry ice.

20. The method according to claim 1, wherein a plurality of carriers are provided in a spaced-apart relationship and adapted to receive said dry ice at desired time intervals.

21. The method according to claim 19, further comprising:
accelerating the sublimation of the dry ice dispensed on the floor portion of the vertical shaft by the use of a heat source.

22. The method according to claim 19, further comprising:
accelerating the sublimation of the dry ice dispensed on the floor portion of the vertical shaft by providing salt crystals on said floor portion.
